(19) United States
(12) Patent Application Publication
(10) Pub. No.: US 2026/0254346 A1
(43) Pub. Date: Aug. 27, 2026

(54) VOLTAGE/CURRENT OR CURRENT/VOLTAGE CONVERSION SYSTEM

(71) Applicants: SYNCHROTRON SOLEIL, SAINT-AUBIN (FR); CONSERVATOIRE NATIONAL DES ARTS ET METIERS, PARIS CEDEX 03 (FR); CENTRE NATIONAL DE LA RECHERCHE SCIENTIFIQUE, PARIS (FR); CY CERGY PARIS UNIVERSITE, CERGY-PONTOISE CEDEX (FR); ECOLE NORMALE SUPERIEURE PARIS-SACLAY, GIF-SUR-YVETTE (FR); UNIVERSITE PARIS-SACLAY, GIF-SUR-YVETTE (FR)

(72) Inventors: François BOUVET, GIF-SUR-YVETTE (FR); Eric DUPUY, PECQUEUSE (FR); Ayawo Roger EKON, GIF-SUR-YVETTE (FR); Mickaël PETIT, PALAISEAU (FR)

(73) Assignees: SYNCHROTRON SOLEIL, SAINT-AUBIN (FR); CONSERVATOIRE NATIONAL DES ARTS ET METIERS, PARIS CEDEX 03 (FR); CENTRE NATIONAL DE LA RECHERCHE SCIENTIFIQUE, PARIS (FR); CY CERGY PARIS UNIVERSITE, CERGY-PONTOISE CEDEX (FR); ECOLE NORMALE SUPERIEURE PARIS-SACLAY, GIF-SUR-YVETTE (FR); UNIVERSITE PARIS-SACLAY, GIF-SUR-YVETTE (FR)

(21) Appl. No.: 18/995,387

(22) PCT Filed: Jun. 28, 2023
(86) PCT No.: PCT/EP2023/067661

§ 371 Date: Jan. 16, 2025

(30) Foreign Application Priority Data
Jul. 25, 2022 (FR) FR2207637

(51) Int. Cl. H02M 1/15; H02M 1/088; H02M 1/14; H02M 3/158

(52) U.S. Cl. CPC H02M 1/15; H02M 1/088; H02M 1/143; H02M 3/158

(57) ABSTRACT

A voltage/current or current/voltage conversion system, including input and output terminals, and between these terminals: a first and a second set, each set including at least one switching cell, the switching cell(s) of the first set and the switching cell(s) of the second set being associated in pairs so that each switching cell of the first set is associated with a single switching cell of the second set; and a control device is arranged and/or programmed to send, to the switches of the switching cells, a signal is arranged to cause the switches to switch between their on and off states at the same switching frequency for all the switches so that, for each pair of switching cells, the first switch of the first set of the pair is off when the first switch of the second set of the pair is on, and vice versa.

### TECHNICAL FIELD

The present invention relates to a voltage-to-current or current-to-voltage conversion system. It also relates to a method for converting voltage to current or current to voltage.

The field of the invention is more particularly, but not exclusively, that of voltage-to-current or current-to-voltage conversion of electromagnet power supplies in particle accelerators.

### PRIOR ART

By design, switch-mode electronics induce a current ripple that can be detrimental to the load powered by the converter. This is the case, for example, for electromagnet power supplies in particle accelerators, which must provide a perfectly smooth current with very low ripple.

The aim of the present invention is to reduce this current ripple as much as possible without reducing the system's (dynamic) bandwidth. Indeed, using the example of power supplies for particle accelerators, achieving high dynamics is another essential condition for the proper operation of beam position correction systems.

The most widespread filtering solution is based on passive elements (capacitors and inductors); active filter solutions are also used, with transistors operating in linear mode.

With passive filtering, to achieve high dynamic range (and at the same time a very good filtering level), it is necessary to increase the switching frequency of the power switches. This reduces the size (and volume) of the converter's output filter. This results in converter efficiency deterioration, with a particular increase in losses dissipated (by switching) by the power semiconductors. To limit their temperature and maximize their reliability, it may be necessary to oversize the heatsinks on which they are mounted. Moreover, the parasitic elements inherent in the components performing the filtering limit the frequency range for which the filter is effective. Above a few hundred kHz switching frequency (when very fast-switching semiconductors are used), achieving good electromagnetic compatibility (EMC) becomes much more complicated. To limit this increase in switching frequency, high-order filters (typically order 5) can be used, obtained by combining several passive filtering cells. These filters, calculated to provide equivalent attenuation at the switching frequency compared with a lower-rank filter, have a higher switching frequency to satisfy the high-dynamics constraint. Another solution for limiting the switching frequency is to use so-called “interleaving” techniques for semiconductor control. The general idea is to combine N switching cells in parallel, and to drive them with control signals out of phase with one another by 2π/N. In this way, the apparent frequency “seen” in the load is equal to N times the switching frequency of each cell, thus reducing the size of the output filter and achieving high bandwidths and good efficiencies. One of the disadvantages of this method is the management of the balancing between the currents generated by the N switching cells operating in parallel; additional control loops may be required to guarantee this balancing.

Generally speaking, the passive components and/or the cooler account for a significant proportion of the converter's total volume.

The active filter in linear mode, however, significantly degrades the overall performance. Additionally, its impact on the overall volume and weight of converters is significant, even though it does not use passive components. Indeed, the cooling system associated with the active components will also be bulky.

The purpose of the present invention is therefore to minimize current ripple in a voltage-to-current or current-to-voltage conversion system or method while:
minimizing (dynamic) bandwidth reduction, and/or
maintaining high dynamics, and/or
limiting converter efficiency degradation, and/or
limiting dissipated losses, and/or
limiting the weight or volume of the converter, and/or
reducing the weight and volume of passive components and/or the cooler, and/or
not requiring additional control loops to ensure balancing, and/or
obtaining lower residual levels.

### DISCLOSURE OF THE INVENTION

This objective is achieved with a voltage-to-current or current-to-voltage conversion system, comprising several (typically exactly 2 or 3) input terminals and several (typically exactly 2 or 3) output terminals, and between the input terminals and the output terminals:
a first set and a second set, each of the first set and the second set comprising at least one switching cell,
characterized in that:
the system further comprises a common control device for the first and second sets,
each switching cell comprising:
a first switch which can be in an on state or in an off state, and comprising a transistor, and
a second switch which can be in an on state or an off state, and comprising a transistor and/or a diode,
so that, for each switching cell, this switching cell oscillates between two states, a first state in which its first switch is on when its second switch is off, and a second state in which its first switch is off when its second switch is on,
the number of switching cells in the system being even,
each of the first set and the second set comprises the same number of switching cell(s) (preferably at least one, more preferably exactly one or two or 3).
the at least one switching cell of the first set and the at least one switching cell of the second set being associated in pairs so that each switching cell of the first set is associated with a single switching cell of the second set, and each switching cell of the second set is associated with a single switching cell of the first set,
the control device being arranged and/or programmed to send to the switches of the switching cells a signal arranged to switch the switches between their on state and their off state at the same switching frequency (F_{dec}) for all the switches so that, for each pair of switching cells, the first switch of the switching cell of the first set of the pair is off when the first switch of the switching cell of the second set of the pair is on, and the first switch of the switching cell of the first set of the pair is on when the first switch of the switching cell of the second set of the pair is off.

Each switching cell of the second set can be connected to one of the output terminals or one of the input terminals via an inductor and a capacitor:
said capacitor being arranged to suppress a DC current component, and/or
this inductor and capacitor forming a high-pass filter with a switching frequency F_{cfa} significantly lower than the switching frequency F_{dec} so that 100×F_{cfa}<F_{dec}.

The switching cells of the first set and the second set can together form a four-quadrant chopper structure.

The two sets can be connected in parallel between the input and output terminals:
the first set comprising a main converter, each switching cell of the first set being a switching cell of the main converter
the second set comprising an switched-mode active compensator, each switching cell of the second set being a switching cell of the switched-mode active compensator.

The switching cell(s) of the main converter can be identical in structure to the switching cell(s) of the compensator.

The main converter switching cell(s) can have a series chopper structure, and the compensator switching cell(s) can have a series chopper structure.

The main converter switching cell(s) can have a two-quadrant chopper structure, and the compensator switching cell(s) can have a two-quadrant chopper structure.

The main converter switching cell(s) can have a four-quadrant chopper structure, and the compensator switching cell(s) can have a four-quadrant chopper structure.

The main converter switching cell(s) can have a “boost chopper” structure, and the compensator switching cell(s) can have a “boost chopper” structure.

The main converter switching cell(s) can be designed as a buck-boost chopper, and the compensator switching cell(s) can be designed as a buck-boost chopper.

The second set can be arranged to generate a current ripple, with zero mean value, of the same amplitude but in phase opposition to that generated by the first set.

The two first switches of the same pair of switching cells can be connected to the same input terminal(s) and output terminal(s) without passing through a transistor or switch.

The two second switches of the same pair of switching cells can be connected to the same input terminal(s) and output terminal(s) without passing through a transistor or switch.

Preferably, no switching cell is connected to an input terminal via a transistor.

Preferably, no switching cell is connected to an output terminal via a transistor.

Each switching cell can be connected to both input terminals without any intermediate elements.

Each switching cell can be connected to one of the output terminals without any intermediate elements.

Each switching cell can be connected to one of the output terminals via an inductor.

Each switching cell of the first set can be connected to one of the output terminals via an inductor only.

Each switching cell of the second set can be connected to one of the output terminals via an inductor and a capacitor.

Each switching cell can be connected to both output terminals without any intermediate elements.

Each switching cell can be connected to one of the input terminals without any intermediate elements.

Each switching cell can be connected to one of the input terminals via an inductor.

Each switching cell of the first set can be connected to one of the input terminals via an inductor only.

Each switching cell of the second set can be connected to one of the input terminals via an inductor and a capacitor.

Each inductor of the first set can be coupled with an inductor of the second set.

The switching cell transistors can comprise MOSFET and/or IGBT and/or GaN FET transistors.

According to yet another aspect of the invention, a method of controlling a system according to the invention is proposed, characterized in that it comprises a common control, by the control device, of the first set and of the second set, by sending the switches of the switching cells a signal causing the switches to toggle between their on state and their off state at the same switching frequency for all the switches so that:
for each switching cell, this switching cell oscillates between two states, a first state in which its first switch is on when its second switch is off, and a second state in which its first switch is off when its second switch is on,
for each pair of switching cells, the first switch of the switching cell of the first set of the pair is off when the first switch of the switching cell of the second set of the pair is on, and the first switch of the switching cell of the first set of the pair is on when the first switch of the switching cell of the second set of the pair is off.

Each switching cell of the second set can be connected to one of the output terminals or one of the input terminals via an inductor and a capacitor:
this capacitor suppressing a DC current component, and/or
this inductor and capacitor forming a high-pass filter with a switching frequency F_{cfa} significantly lower than the switching frequency F_{dec} so that 100×F_{cfa}<F_{dec}

Preferably, the second set generates a current ripple of the same amplitude but in phase opposition to that generated by the first set.

### DESCRIPTION OF THE FIGURES AND EMBODIMENTS

Other benefits and features shall become evident upon examining the detailed description of entirely non-limiting embodiments and implementations, and from the following enclosed drawings:

FIG. 1 shows a first embodiment of a “step-down” system 101 according to the invention, which is the preferred embodiment of the invention,

FIG. 2 shows further system embodiments (102, 103 in FIG. 2a; 202, 203 in FIG. 2b) according to the invention,

FIG. 3 shows in part a) embodiment 102 embodiment 103 and in part c) another embodiment 104 of a system according to the invention,

FIG. 4 shows different system embodiments (202 in FIG. 4a; 203 in FIG. 4b; 204 in FIG. 4c; 201 in FIG. 4d) according to the invention,

FIG. 5 shows different embodiments of “rectifier” systems 302, 303 according to the invention,

FIG. 6 shows a three-phase “step-down” system 504 according to the invention,

FIG. 7 shows a system 102 with a series chopper-type static converter 61 as shown in FIGS. 2a and 3a,

FIG. 8 shows different signals (commands, voltages or currents) as a function of time in the system shown in FIGS. 3a and 7,

FIG. 9 shows, in part a) a circuit diagram, using the PSIM electronic simulation software, of the system 103 of FIGS. 2a and 3b; in part b), different signals (commands, voltages or currents) as a function of time for this system,

FIG. 10, in part a) a circuit diagram, using the PSIM electronic simulation software, of the system 303 of FIGS. 5a and 5b; in part b), different signals (commands, voltages or currents) as a function of time for this system,

FIG. 11, in part a) a circuit diagram, using the PSIM electronic simulation software, of the system 504 of FIGS. 6a and 6b; in part b), different signals (commands, voltages or currents) as a function of time for this system,

FIG. 12 shows a comparison, at a given load current filtering level, of the dynamics obtained for a reference 71 and with 73 and without 72 active compensator 62, for a system 104 of FIG. 3c with a 4-quadrant full-bridge chopper converter,

FIG. 13 shows a comparison, at a given bandwidth, of the filtering level obtained for a reference 81 and with 83 and without 82 active compensator, for a system 104 of FIG. 3c with a 4-quadrant full-bridge chopper converter, and

FIG. 14 shows a basic static converter structure, referred to as a “switching cell”, for any of the system embodiments according to the invention described with reference to the preceding figures.

These embodiments are in no way limiting, and in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior art. This selection comprises at least one preferably functional feature which lacks structural details, and/or only has a portion of the structural details if that portion is only sufficient to confer a technical benefit or to differentiate the invention with respect to the prior state of the art.

Very generally, a static converter is an interface between a source of electrical energy 300 and a load 400. Its primary purpose is thus to control the transfer of energy between source and load. The various conversion families in particular include choppers, which perform direct-direct (DC-to-DC) conversion, inverters, which perform direct-alternating (DC-to-AC) conversion, and rectifiers, which perform alternating-direct (AC-to-DC) conversion. All these forms (DC-DC) (DC-AC) and (AC-DC) are applicable to the present invention.

The notion of efficiency is paramount: the conversion device must have minimal losses, which implies the use of theoretically non-dissipative elements:
Switches made using semi-conductor components, with two static states, on and off,
Passive, purely reactive components, such as capacitors, transformers and inductors, used inter alia for transient energy storage and filtering.

As will be seen later, each of the embodiments described hereinafter comprises a voltage-to-current or current-to-voltage conversion system, comprising input terminals 31, 32 and output terminals 41, 42, and between the input terminals 31, 32 and the output terminals 41, 42:
a first set 1 and a second set 2, each of the first set and the second set comprising at least one switching cell.

Each of the embodiments described hereinafter further comprises a common control device 3 for the first set 1 and the second set 2.

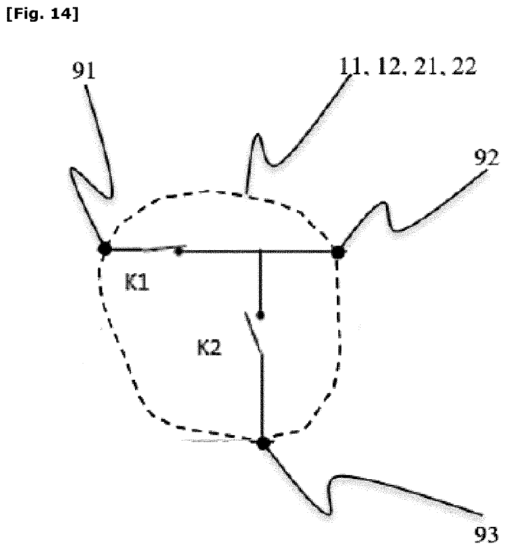

The fundamental structures of static converters, referred to hereinafter as “switching cells” 11, 12, 21, 22, can be linked together like basic building blocks. The simplest “switching cell” conversion structure necessarily uses 2 switches (K1 and K2 in FIG. 14) whose functions are linked: their states are necessarily complementary. One is off when the other is on. This basic structure is called a “switching cell”.

The switching cell 11, 12, 21, 22 typically comprises three terminals:
the first switch K1 (hereinafter referred to as 111, 121, 211, or 221) connects the first terminal 91 to the second terminal 92
the second switch K2 (hereinafter referred to as 112, 122, 212 or 222) connects the third terminal 93 to the second terminal 92
the first switch K1 and the second switch K2 in series connect the first terminal 91 to the third terminal 93.

These two switches, if connected to a voltage source, cannot be closed (that is, in their on state) at the same time (but it is possible to open them at the same time); otherwise a short-circuit will occur, damaging the equipment. Similarly, if the cell is connected to a current source, it is not possible to open both switches at the same time (that is, put them in their blocking state); however, it is possible to close them at the same time.

The second set 2 is designed to generate a current ripple, with zero mean value, of the same amplitude but in phase opposition to that generated by the first set 1 (in the case of a current-to-voltage conversion variant, the active compensator will filter the current this time at the system input (and not at the output as in the case of voltage-to-current conversion), again generating a current ripple in phase opposition to the main converter).

As will be seen below, each of the system embodiments according to the invention described below comprises:
Downstream (in the case of “step-down” systems) or upstream (in the case of “rectifier” systems) of the switching cells of the first set 1 and/or the second set 2, at least one inductor L, L₁, L₂, L₃, each of these inductors being a so-called main inductor arranged to limit current variations, each of these main inductors being alone, that is, not connected in series with a capacitor and electrically connected between the switching cells of the first or second set (only the first set 1 for all the figures except 1 and 4d) and one of the outputs 41, 42, 43 (in the case of “step-down” systems) and/or one of the inputs 31, 32, 33 (in the case of “rectifier” systems).
Downstream (in the case of “step-down” systems) or upstream (in the case of “rectifier” systems) of the switching cells of the first set 1 and/or the second set 1, at least one so-called filtering inductor L_{FA}, L_{FA1}, L_{FA2}, L_{FA3} belonging to a high-pass filter, each of these filtering inductors being connected in series to a so-called filtering capacitor C_{FA}, C_{A1}, C_{FA2} and C_{FA3} arranged to suppress the DC component of the generated current, each of these high-pass filters being electrically arranged between the switching cells of the first 1 and/or second 2 set (only of the second set 2 for all figures except 1 and 4d) and one of the outputs 41, 42, 43 (in the case of “step-down” systems) or one of the inputs 31, 32, 33 (in the case of “rectifier” systems).

In the figures, C denotes the opening (C=0 on state) and closing (C=1 off or closed state) command for each transistor, and C̅ the complementary command (C̅=1 off state if C=0 on state and C̅=0 state on if C=1 off state).

The filtering capacitor (C_{FA}, C_{FA1}, C_{FA2} and C_{FA3}) suppress the DC component of the compensator output current; the current ripples of the compensator and main converter are then perfectly symmetrical with respect to a horizontal axis, which makes it possible to cancel out almost all of the ripple in the converter output current (this output current being, to a first approximation, equal to the sum of the current generated by the compensator and the current delivered by the main converter). In this way, the size of the output filter of the main converter can be reduced and the high dynamic constraint can be met. Moreover, since the average current through the compensator inductor is zero, the losses developed in the inductor are low.

It will further be noted that the filtering capacitor (C_{FA}, C_{FA1}, C_{FA2} and C_{FA3}) does not connect (or at least does not connect directly or without passing through its filtering inductor L_{FA}, L_{FA1}, L_{FA2}, L_{FA3}, respectively, and/or through a switching cell) the two terminals 41, 42 to one another or the two terminals 31, 32 to one another.

A capacitor C_{add} (not shown), directly connecting the two terminals 41, 42 to one another or the two terminals 31, 32 to one another, can be added in the present embodiments of the invention shown in all the figures, but its technical function would, due to its location, be different from the filtering capacitor (C_{FA}, C_{FA1}, C_{FA2} and C_{FA3}, RESPECTIVELY). Such an additional filtering capacitor C_{add} would have the following technical function:
Since the inductance values of the compensator and main converter are never exactly the same, compensation will never be completely perfect. A capacitor C_{add} would filter out any residual ripple.
This capacitor C_{add} can also be used to filter out high-frequency disturbances (well above the switching frequency) induced by switching of the switches, to perfect electromagnetic compatibility.

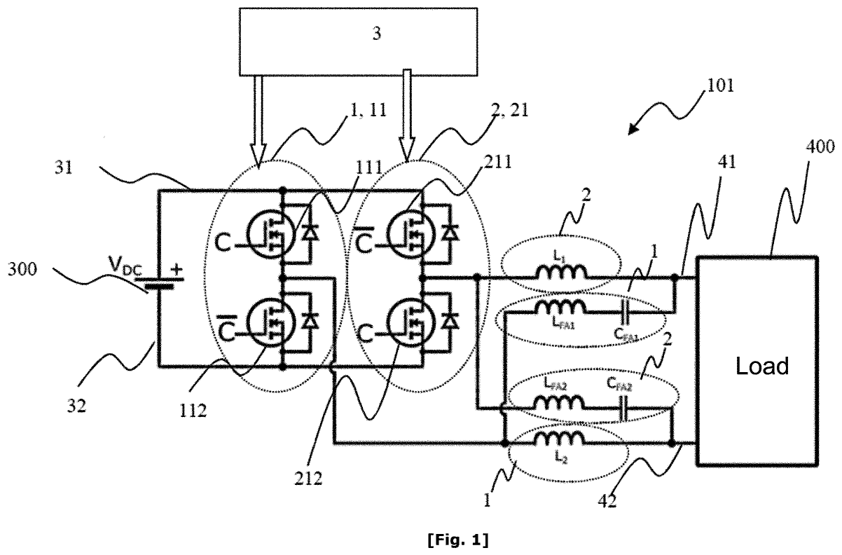

With reference to FIG. 1, a first embodiment of a system 101 according to the invention will first be described, which is a voltage-to-current conversion system 101, comprising input terminals 31, 32 (two in the case of FIG. 1) connected respectively to the terminals of the source 300 and output terminals 41, 42 (two in the case of FIG. 1) connected respectively to the terminals of the load 400.

The system 101 comprises, both between the input terminals 31, 32 and the output terminals 41, 42:
a first set 1 and a second set 2, each of the first set 1 and the second set 2 comprising at least one switching cell 11, 21, and even exactly one switching cell in the case of FIG. 1.

The system 101 further comprises a common control device 3 for the first set 1 and the second set 2.

The control device 3 comprises at least one computer, a central processing or computing unit, an analog electronic circuit (preferably dedicated), a digital electronic circuit (preferably dedicated), and/or a microprocessor (preferably dedicated), and/or software means.

Each switching cell 11, 21 respectively comprises:
a first switch 111 or 211, respectively, which can be in an on state or in an off state, and comprising a transistor, and
a second switch 112 or 212, respectively, which can be in an on state or an off state, and comprising a transistor and/or a diode, so that, for each switching cell 11 or 21, this switching cell oscillates between two states, a first state in which its first switch 111 or 211, respectively, is on when its second switch 112 or 212, respectively, is off, and a second state in which its first switch 111 or 211, respectively, is off when its second switch 112 or 212, respectively, is on, with possible transient phases of this cell during which these two switches 111 and 112, or 211 and 212, may both be off (but in no case both on).

In the case of FIG. 1:
the switch 111 or 211 comprises a transistor, and this transistor is referred to as “high side” or high potential and has its drain connected to the positive terminal of the voltage source 300
the switch 112 or 212, if it comprises a transistor, then this transistor is said to be “low side” or low potential and has its source connected to the negative terminal or ground of the voltage source 300 With reference to FIGS. 1 and 14, each switching cell 11, 21:
has its first terminal 91 electrically connected (preferably corresponding) to the terminal 31
has its third terminal 93 electrically connected (preferably corresponding) to the terminal 32
has its second terminal 92 electrically connected to the two output terminals 41 and 42.

In the case of a set comprising a single switching cell, “each switching cell” of the set means the switching cell of the set.

Each transistor of the switching cells typically comprises a metal oxide semiconductor field effect transistor (MOSFET) and/or an insulated gate bipolar transistor (IGBT) and/or a gallium nitride field effect transistor (GaN FET).

An on state of a switch is a state that allows an electric current to flow through the switch.

An off state of a switch is a state that does not allow an electric current to flow through the switch.

The number of switching cells 11, 21 in the system is even, and equal to two.

Each of the first set 1 and the second set 2 comprises the same number (only one in the case of FIG. 1) of switching cell(s) 11, 21.

The at least one switching cell 11 of the first set 1 and the at least one switching cell 21 of the second set 2 are associated in pairs so that each switching cell 11 of the first set 1 is associated with a single switching cell 21 of the second set 2, and each switching cell 21 of the second set 2 is associated with a single switching cell 11 of the first set 1.

The control device 3 is arranged and/or programmed to send to the switches 111, 112, 211, 212 of the switching cells 11, 21 a signal (or command) C or C arranged to switch the switches 111, 112, 211, 212 between their on state and their off state (and/or vice versa) at the same switching frequency (typically between 5 kHz and 500 kHz) for all switches 111, 112, 211, 212 so that, for each pair of switching cells 11, 21, the first switch 111 of the switching cell 11 of the first set 1 of the pair is off when the first switch 211 of the switching cell 21 of the second set 2 of the pair is on, and the first switch 111 of the switching cell 11 of the first set 1 of the pair is on when the first switch 211 of the switching cell 21 of the second set 2 of the pair is off, with possible transient phases of this pair during which these two first switches 111, 211 of this pair can both be off (but in no case both on).

In other words, the control device 3 is arranged and/or programmed to send, for each pair of switching cells 11, 21:
a signal (or command), respectively C or C, to the first switch 111 of the switching cell 11 of the first set 1 of the pair
a complementary signal (or command), respectively C or C, to the first switch 211 of the switching cell 21 of the second set 2 of the pair.

Power electronics are therefore switching electronics (ideally, an open or closed switch does not dissipate energy). This changeover frequency of the switches is called the “switching frequency”. At each switching cycle, a quantum of energy is transferred between the source 300 and the load 400. The control of the energy transfer between the source 300 and the load 400 is achieved by modulating the conduction time of the switches: at each switching cell, at least one of the two switches must therefore be controllable (on and/or off). Transistors (for example MOSFETs) are switches that can be controlled or monitored on opening and closing.

In the case of FIG. 1, the switching cells 11, 21 of the first set 1 and the second set can together form a four-quadrant chopper structure.

The second set 2 is arranged to generate a current ripple of the same amplitude but in phase opposition to that generated by the first set 1.

The two first switches 111, 211 of the same pair of switching cells 11, 21 are electrically connected:
through the terminal 91 of each cell, to the same input terminal 31, without passing through a transistor or switch 111, 211, 112, 212 (or a capacitor or inductor)
through the terminal 92 of each cell, to the same output terminals 41, 42 without passing through a transistor or switch 111, 211, 112, 212, but passing through:
a main inductor L1 for the cell 21 to the output 41
a filtering inductor L_{FA1} (and a filtering capacitor C_{FA1}) for the cell 11 to the output 41
a filtering inductor L_{FA2} (and a filtering capacitor C_{FA2}) for the cell 21 to the output 42
a main inductor L2 for the cell 11 to the output 42

The second two switches 112, 212 of the same pair of switching cells 11, 21 are electrically connected:
through the terminal 93 of each cell, to the same input terminal 32, without passing through a transistor or switch (or a capacitor or inductor), and
through the terminal 92 of each cell, to the same output terminals 41, 42 without passing through a transistor or switch, but passing through:
a main inductor L1 for the cell 21 to the output 41
a filtering inductor L_{FA1} (and a filtering capacitor C_{FA1}) for the cell 11 to the output 41
a filtering inductor L_{FA2} (and a filtering capacitor C_{FA2}) for the cell 21 to the output 42
a main inductor L2 for the cell 11 to the output 42

No switching cell 11, 21 is electrically connected to an input terminal 31, 32 via a transistor.

No switching cell 11, 21 is electrically connected to an output terminal 41, 42 via a transistor.

Each switching cell 11, 21 is electrically connected to both input terminals 31, 32 without any intermediate elements.

Each switching cell 11, 21 is electrically connected to:
one of the output terminals 41 or 42 via a main inductor
the other of the output terminals 42 or 41, respectively, via a filtering inductor in series with a filtering capacitor.

Each switching cell 11, 21 is electrically connected to one of the output terminals 41, 42 via an inductor.

Each switching cell 11 of the first set 1 is electrically connected to one of the output terminals 42 via a main inductor L₂ only.

Each switching cell 21 of the second set 2 is electrically connected to one of the output terminals 42 via a filtering inductor L_{FA2} and a filtering capacitor C_{FA2} only.

Whatever the variant considered in the present description, the source 300 at the input terminals 31, 32 is a DC voltage source (battery, capacitor-filtered output of an AC-DC converter, etc.).

The load 400 at the output terminals 41, 42 may, for example, be any type of device requiring DC power (battery, MCC-type rotating machine, electromagnet, etc.), or low-frequency power (grid injection, AC rotating machines, electromagnet, etc.) typically below one kilohertz.

In the case of the system 101, a main converter groups together the first set 1 and the second set 2 and is a four-quadrant chopper, and the structure of the system 101 is simplified (no auxiliary converter is needed) compared with the systems 102, 103, 104 described below.

L₁, L_{FA1}, C_{FA2} are part of the second set 2.

L₂, L_{FA1}, C_{FA1} are part of the first set 1.

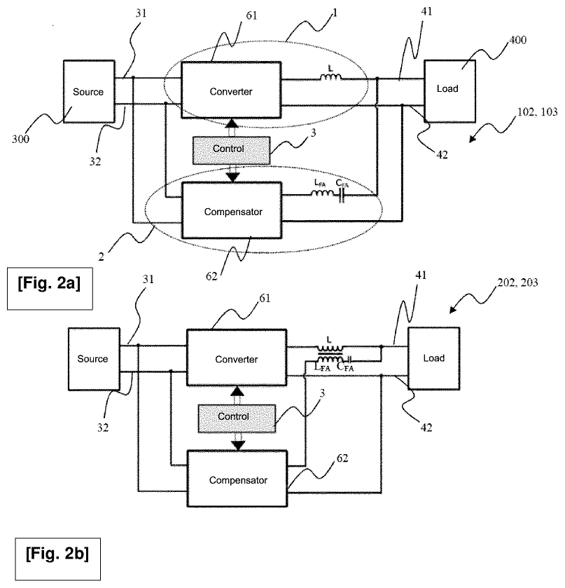

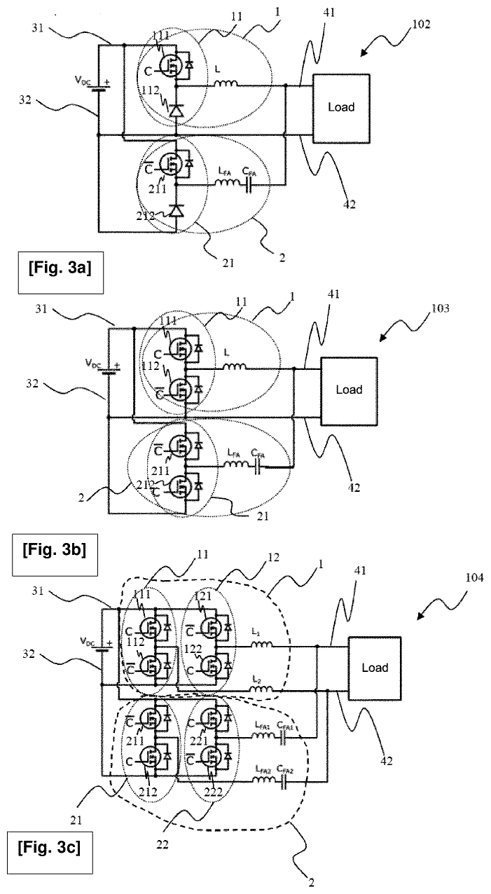

With reference to FIGS. 2a, 3a, 3b, 3c, further embodiments of systems 102, 103, 104 according to the invention will now be described, which will be described only in terms of their differences from the system 101, and which are also voltage-to-current conversion systems, comprising input terminals 31, 32 (two in the case of FIGS. 2a, 3a, 3b, 3c) and output terminals 41, 42 (two in the case of FIGS. 2a, 3a, 3b, 3c).

In all these systems 102, 103, or 104, the two sets 1, 2 are connected in parallel between the input terminals 31, 32 and the output terminals 41, 42:
the first set 1 comprises a main converter 61 which comprises all the switching cells of the first set 1, each switching cell 11, 12 of the first set being a switching cell of the main converter
the second (2) set comprising an switched-mode active compensator 62 which comprises all the switching cells of the second set 2, each switching cell 21, 22 of the second set being a switching cell of the switched-mode active compensator.

The main inductors L, L₁, L₂, etc. are part of the first set 1.

The filtering inductors L_{FA}, L_{FA1}, L_{FA2}, etc. and the filtering capacitors C_{FA}, C_{FA1}, C_{FA2}, etc. are part of the second set 2.

The switched-mode active compensator 62 is therefore designed to benefit from the advantages of both passive and active components. The principle of the compensator 62 according to the invention is therefore to generate a current ripple opposite that generated by the main converter 61. Superimposing the main converter current 61 and the compensator current 62 cancels out almost all the ripple of the converter 61. In this way, the size of the output filter of the main converter 61 can be reduced and the high dynamic constraint can be met.

The system 102, 103, or 104 therefore has the following advantages:
This filtering solution, based on an switched-mode active compensator 62, significantly reduces the proportion of passives in the filter (no more cascaded passive low-pass filtering cells).
The active switching filter guarantees good bandwidth while operating at a lower switching frequency than a passive filter.
The active compensator 62 does not impair the overall efficiency of the system 102, 103 or 104, and consumes very little power.
It is easy to use.

Unlike active filters, which are concerned with common-mode EMC disturbances at the converter input, the active compensator 62 proposed here addresses disturbances (at the switching frequency) of the differential-mode output current wave.

The main converter 61 is a static converter, preferably bidirectional in current (although unidirectional static converters are also possible), and the compensator 62 is a static converter of the same type.

The system 102, 103 or 104 comprises, both between the input terminals 31, 32 and the output terminals 41, 42:
a first set 1 and a second set 2, each of the first set 1 and the second set 2 comprising at least one switching cell 11, 12, 21, 22 and even exactly one switching cell in the case of FIG. 3a or 3b and two switching cells in the case of FIG. 3c.

The system 102, 103 or 104 further comprises a common control device 3 for the first set 1 and the second set 2.

Each switching 11, 21, 12 or 22 comprises:
a first switch 111, 211, 121 or 221, respectively, which can be in an on state or in an off state, and comprising a transistor, and
a second switch 112, 212, 122 or 222, respectively, which can be in an on state or an off state, and comprising a transistor and/or a diode, so that, for each switching cell 11, 21, 12 or 22, this switching cell oscillates between two states, a first state in which its first switch 111, 211, 121 or 221, respectively, is on when its second switch 112, 212, 122 or 222, respectively, is off, and a second state in which its first switch 111, 211, 121 or 221, respectively, is off when its second switch 112, 212, 122 or 222, respectively, is on, with possible transient phases of this cell during which these two switches 111 and 112, or 211 and 212 or 121 and 122 or 221 and 222, may both be off (but in no case both on).

The number of switching cells 11, 21, 12, or 22 in the system 102, 103, or 104 is even, and equal to two for FIG. 3a or 3b or four for FIG. 3c.

Each of the first set 1 and the second set 2 comprises the same number (one for FIG. 3a or 3b or two for FIG. 3c) of switching cell(s) 11, 21, 12, or 22.

The at least one switching cell 11, 12 of the first set 1 and the at least one switching cell 21, 22 of the second set 2 are associated in pairs so that each switching cell 11 or 12 of the first set 1 is associated with a single switching cell 21 or 22, respectively, of the second set 2, and each switching cell 21 or 22 of the second set 2 is associated with a single switching cell 11 or 12, respectively, of the first set 1.

The control device 3 is arranged and/or programmed to send the switches 111, 211, 121, 221, 112, 212, 122, 222 of the switching cells 11, 21, 12 or 22 a signal (or command) C or C arranged to switch the switches 111, 211, 121, 221, 112, 212, 122, 222 between their on state and their off state (and/or vice versa) at the same switching frequency (typically between 5 kHz and 500 kHz) for all the switches 111, 211, 121, 221, 112, 212, 122, 222 so that, for each pair of switching cells (pair 11, 21 and pair 12, 22), the first switch 111 or 121, respectively, of the switching cell 11 or 12, respectively, of the first set 1 of the pair is off when the first switch 211 or 221, respectively, of the switching cell 21 or 22, respectively, of the second set 2 of the pair is on, and the first switch 111 or 121, respectively, of the switching cell 11 or 12, respectively, of the first set 1 of the pair is on when the first switch 211 or 221, respectively, of the switching cell 21 or 22, respectively, of the second set 2 of the pair is off, with possible transient phases of this pair during which these two first switches of this pair can both be off (but in no case both on).

The second set 2 is arranged to generate a current ripple of the same amplitude but in phase opposition to that generated by the first set 1.

Thus, the electrical diagram wherein the system 102, 103 or 104 fits comprises:
a power source and its input terminals 31, 32,
a load and its output terminals 41, 42,
a main static converter 61 responsible for transferring electrical energy from the source to the load (and vice versa if reversible).

The active compensator 62 is connected in parallel with the main converter 61. The converter 61 and the compensator 62 are powered by the same source and controlled by the same remote control circuit 3. They both operate at the same switching frequency.

Downstream of the main static converter 61, current variations are limited by a main inductor L, L₁ or L₂.

Downstream of the compensator 62, these variations are limited by a high-pass filter consisting of a filtering inductor L_{FA}, L_{FA1}, L_{FA2}, respectively (of the same value as L, L₁ or L₂ of the main converter 61) in series with a filtering capacitor C_{FA}, C_{FA1}, C_{FA2} to suppress the DC component of the generated current.

The inductors L, L₁ or L₂ located downstream of the converter 61 and the inductors L_{FA}, L_{FA1}, L_{FA2} located downstream of the compensator 62 are independent.

The two first switches 111, 211 or 121, 221 of the same pair of switching cells 11, 21 or 12, 22 are electrically connected to the same input terminal(s) and output terminal(s) without passing through a transistor or switch 111, 211, 112, 212.

More precisely:
The two first switches 111, 211 of the pair of switching cells 11, 21 are electrically connected:
through the terminal 91 of each cell, to the same input terminal 31, without passing through a transistor or switch 111, 211, 121, 221, 112, 212, 122, 222 (or through a capacitor or inductor)
In the case of FIGS. 3a and 3b: via the terminal 92 of each cell, to the same output terminal 41 without passing through a transistor or switch 111, 211, 121, 221, 112, 212, 122, 222 (but passing through an inductor alone L or via an inductor L_{FA} in series with a capacitor C_{FA})
In the case of FIG. 3c: via the terminal 92 of each cell, to the same output terminal 42 without passing through a transistor or switch 111, 211, 121, 221, 112, 212, 122, 222 (but passing through an inductor alone L₂ or via an inductor L_{FA2} in series with a capacitor C_{FA2})
In the case of FIG. 3c: The two first switches 121, 221 of the pair of switching cells 12, 22 are electrically connected:
through the terminal 91 of each cell, to the same input terminal 31, without passing through a transistor or switch 111, 211, 121, 221, 112, 212, 122, 222 (or through a capacitor or inductor)
via the terminal 92 of each cell, to the same output terminal 41 without passing through a transistor or switch 111, 211, 121, 221, 112, 212, 122, 222 (but passing through an inductor alone L1 or via an inductor L_{FA1} in series with a capacitor C_{FA1})
The two second switches 112, 212 of the pair of switching cells 11, 21 are electrically connected:
through the terminal 93 of each cell, to the same input terminal 32, without passing through a transistor or switch 111, 211, 121, 221, 112, 212, 122, 222 (or through a capacitor or inductor)
In the case of FIGS. 3a and 3b: via the terminal 92 of each cell, to the same output terminal 41 without passing through a transistor or switch 111, 211, 121, 221, 112, 212, 122, 222 (but passing through an inductor alone L or via an inductor L_{FA} in series with a capacitor C_{FA})
In the case of FIGS. 3a and 3b: through the terminal 93 of each cell, to the same output terminal 42, without passing through a transistor or switch 111, 211, 121, 221, 112, 212, 122, 222 (or through a capacitor or inductor)
In the case of FIG. 3c: via the terminal 92 of each cell, to the same output terminal 42 without passing through a transistor or switch 111, 211, 121, 221, 112, 212, 122, 222 (but passing through an inductor alone L₂ or via an inductor L_{FA2} in series with a capacitor C_{FA2})
In the case of FIG. 3c: The two second switches 122, 222 of the pair of switching cells 12, 22 are electrically connected:
through the terminal 93 of each cell, to the same input terminal 32, without passing through a transistor or switch 111, 211, 121, 221, 112, 212, 122, 222 (or through a capacitor or inductor)
via the terminal 92 of each cell, to the same output terminal 41 without passing through a transistor or switch 111, 211, 121, 221, 112, 212, 122, 222 (but passing through an inductor alone L₁ or via an inductor L_{FA1} in series with a capacitor C_{FA1})

The two second switches 112, 212 of the same pair of switching cells 11, 21 are electrically connected to the same input terminal(s) 31, 32 and output terminal(s) 41, 42 without passing through a transistor or a switch, but optionally by means of an inductor or an inductor and a capacitor in series.

No switching cell 11, 21, 12 or 22 is electrically connected to an input terminal 31, 32 via a transistor.

No switching cell 11, 21, 12 or 22 is electrically connected to an output terminal 41, 42 via a transistor.

Each switching cell 11, 21, 12 or 22 is electrically connected to both input terminals 31, 32 without any intermediate elements.

Each switching cell 11, 21, 12 or 22 is electrically connected to at least one of the output terminals 41, 42 via an inductor.

Each switching cell 11, 12 of the first set 1 is electrically connected to one of the output terminals (41 for FIG. 3a and 3b, 41 or 42 for FIG. 3c) via a main inductor only.

Each switching cell 21, 22 of the second set 2 is electrically connected to one of the output terminals (41 for FIG. 3a and 3b, 41 or 42 for FIG. 3c) via a filtering inductor in series with a filtering capacitor, only.

In FIGS. 3a and 3b, each switching cell 11, 21, 12 or 22 is electrically connected to one of the output terminals 42 without any intermediate elements.

Use of the active filter reduces the size of the passive filtering components used at the output of the main converter 61.

In the particular case of the system 102 shown in FIG. 3a, the switching cell(s) 11 of the main converter have a series chopper structure and the switching cell(s) 21 of the compensator 62 have a series chopper structure.

Both the main converter 61 and the compensator 62 are based on a structure known as a series chopper. In this embodiment, the converter 61 is not current reversible, and the active compensation principle only works if the average value of the current delivered by the main static converter is greater than half the ripple of the current flowing in the inductor downstream of the main converter; this is to avoid the so-called discontinuous current regime, which is reached when the current in the diode cancels out before the end of the switching period.

In the particular case of the system 103 shown in FIG. 3b, the switching cell(s) 11 of the main converter 61 have a two-quadrant chopper structure and the switching cell(s) 21 of the compensator 62 have a two-quadrant chopper structure.

Both the converter 61 and the compensator 62 are based on a structure known as a current-reversible two-quadrant chopper structure.

In the particular case of the system 104 shown in FIG. 3c, the switching cell(s) 11, 12 of the main converter 61 have a four-quadrant chopper structure and the switching cell(s) 21, 22 of the compensator 62 have a four-quadrant chopper structure.

The converter 61, like the compensator 62, is based on a structure known as a four-quadrant full-bridge chopper, reversible in current and voltage.

In the case of FIG. 3c:
the switch 111 or 211 or 121 or 221 comprises a transistor, and this transistor is referred to as “high side” or “high potential” and has its drain connected to the positive terminal of the voltage source 300
the switch 112 or 212 or 122 or 222, if it comprises a transistor, then this transistor is said to be “low side” or “low potential” and has its source connected to the negative terminal or ground of the voltage source 300

With reference to FIGS. 3a, 3b, 3c and 14, each switching cell 11, 12, 21,22:
has its first terminal 91 electrically connected (preferably corresponding) to the input terminal 31
has its third terminal 93 electrically connected (preferably corresponding) to the input terminal 32 (and optionally to the output terminal 42),
has its second terminal 92 electrically connected to the output terminal 41 or 42.

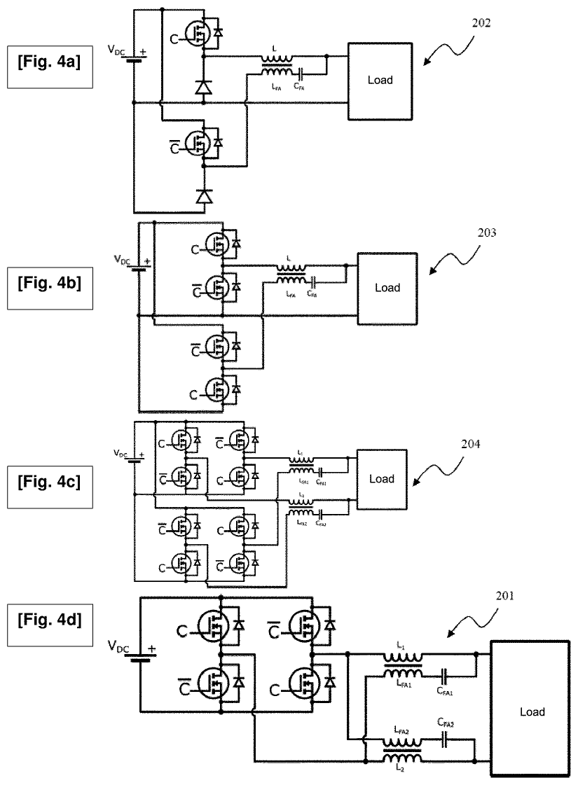

With reference to FIGS. 4d, 2b, 4a, 4b, 4c, further embodiments of systems 201, 202, 203, 204 according to the invention will now be described, which will be described only in terms of their differences from the systems in the figures previously described.

In these figures:
the system 201 in FIG. 4d corresponds to the system 101 in FIG. 1,
the system 202 in FIGS. 2b and 4a corresponds to the system 102 in FIGS. 2a and 3a
the system 203 in FIGS. 2b and 4b corresponds to the system 103 in FIGS. 2a and 3b
the system 204 in FIG. 4c corresponds to the system 104 in FIG. 3c but wherein each respective main inductor L or L₁ or L₂, respectively, of the first set 1 is further coupled with a filtering inductor L_{FA} or L_{FA1} or L_{FA2}, respectively, of the second set 2.

The inductors L, L₁ or L₂ located downstream of the converter 61 and the inductors L_{FA}, L_{FA1}, L_{FA2} located downstream of the compensator 62 are coupled. More precisely, each main inductor L, L₁ or L₂ located downstream of the converter 61 is coupled to one of the filtering inductors L_{FA}, L_{FA1}, L_{FA2} located downstream of the compensator 62.

Use of the active filter reduces the size of the passive filtering components used at the output of the main converter 61. This benefit can be enhanced by coupling the main inductor L, L₁ or L₂ with the inductor L_{FA}, L_{FA1}, L_{FA2} downstream of the active compensator 62.

Thus, the use of coupled inductors reduces the volume of passive components and gives rise to new variants:
the main converter 61 is assumed to be a series chopper, as is the active compensator 62 (FIG. 4-a), or
the main converter 61 is assumed to be a current-reversible two-quadrant chopper, as is the active compensator 62 (FIG. 4-b), or
the main converter 61 is assumed to be a four-quadrant full-bridge chopper, as is the active compensator 62 (FIG. 4-c), or
the structure in FIG. 4-d is simplified, as is that in FIG. 1.

All the systems 101, 102, 103, 104, 201, 202, 203, 204 are “step-down” systems, that is, the output voltage is adjustable and at most equal to the input voltage.

However, the active compensator can be used on “step-up” structures. In this case, instead of compensating for current ripples at the output of the converter 61, compensation takes place on the input currents, which can be interesting for certain applications. The dimensioning of the corresponding active compensator variants is identical to those used for step-down structures. These variants offer the same advantages as the previous ones, owing to their ease of use. They are particularly useful for applications with delocalized sources, such as photovoltaic panels and fuel cells, where filtering the disturbances generated by the switching of power converters on the current supplied by these sources is of particular importance.

Thus, each of these systems 101, 102, 103, 104, 201, 202, 203, 204 can be modified into a “step-up” system 301, 302, 303, 304, 401, 402, 403, 404, respectively (referenced in the present description but not necessarily shown), while remaining within the scope of the present invention, by moving, to the inputs 31, 32, the main inductors L, L₁, L₂, and filtering inductors L_{FA}, L_{FA1}, L_{FA2} and the filtering capacitors C_{FA}, C_{FA1}, C_{FA2} initially placed on the side of the outputs 41, 42 in the “step-down” embodiments.

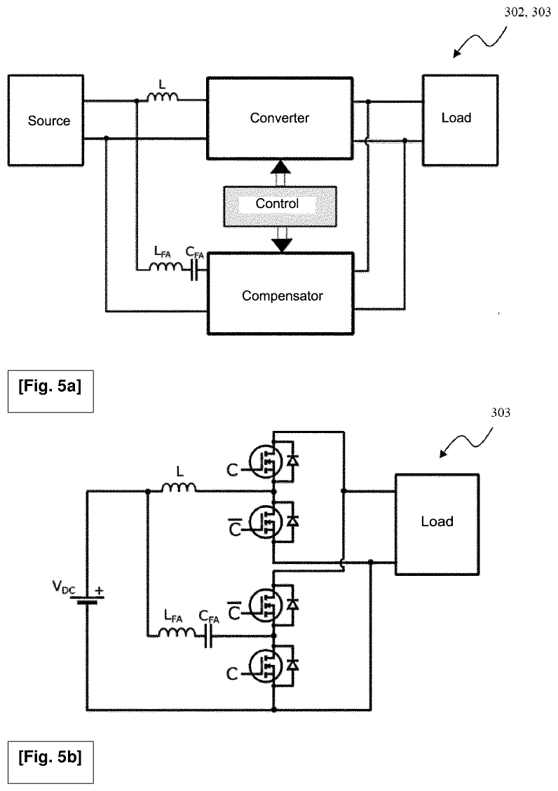

For Example:
FIG. 5a shows a “step-up” system 302, 303 according to the invention, which will only be described in terms of its differences from the system 102, 103 shown in FIG. 2a.
FIG. 5b shows a “step-up” system 303 according to the invention, which will only be described in terms of its differences from the system 103 shown in FIG. 3b.

The “step-up” system 302, 303 shown in FIG. 5b corresponds to the system 103 shown in FIG. 3b, wherein the inductor L, L_{FA}, and capacitors C_{FA} initially placed on the side of the outputs 41, 42 have been moved to the inputs 31, 32. This structure is based on a DC-DC step-up converter (also known as a parallel chopper).

In this case, each switching cell is electrically connected to both output terminals without any intermediate elements.

Each switching cell is electrically connected to one of the input terminals without any intermediate elements.

Each switching cell is electrically connected to one of the input terminals via a main or filtering inductor.

Each switching cell of the first set is electrically connected to one of the input terminals via a main inductor only.

Each switching cell of the second set is electrically connected to one of the input terminals via a filtering inductor in series with a filtering capacitor, only.

In the case of FIG. 5b, the switching cell(s) of the main converter have a “boost chopper” structure, and the switching cell(s) of the compensator have a “boost chopper” structure.

Each of these systems 101, 102, 103, 104, 201, 202, 203, 204, 301, 302, 303, 304, 401, 402, 403, 404 can be modified into a three-phase system, that is, comprising three input terminals and/or three output terminals.

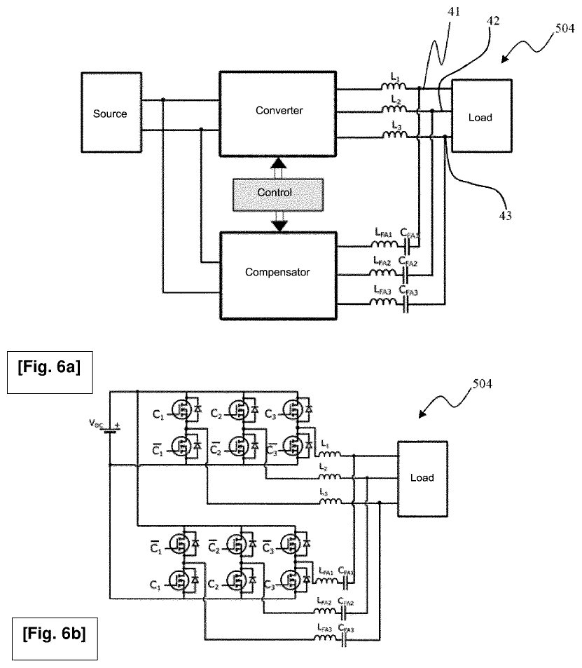

For example, FIGS. 6a and 6b show a “step-down” system 504 according to the invention, which will only be described in terms of its differences from the system 104 of FIG. 3c, and which is merely a three-phase adaptation of the system 104 of FIG. 3c with three output terminals, and for which the main L3 and filtering L_{FA}3 inductors and filtering capacitor C_{FA}3 have therefore been added before the third output 43.

Thus, in addition to the DC-DC converter variants, the system can also be combined with three-phase inverters (step-down structure) or rectifiers (step-up structure). FIG. 6 shows the implementation for a three-phase inverter. Each inverter arm is associated with a compensation stage. Current ripple limitation and compensation inductors must be identical. Variants with coupled inductors remain valid.

Each arm and its compensation stage provide a path for current ripples, which are therefore not transmitted to the load. The capacitors in the compensation stage support the low-frequency (LF) voltage. The coupling of the load (star or delta) is of no importance. Each arm is sized for one line current. Compensation stages are only dimensioned for the maximum ripple value.

In terms of dimensioning, for all the variants shown above, it is possible to choose, for example, depending on the elements present:
L=L_{FA} or substantially equal, plus or minus 20%, ideally plus or minus 5%
L1=L_{FA1} or substantially equal, plus or minus 20%, ideally plus or minus 5%
L2=L_{FA2} or substantially equal, plus or minus 20%, ideally plus or minus 5%
L3=L_{FA3} or substantially equal, plus or minus 20 %, ideally plus or minus 5%
Preferably L=L₁=L₂=L₃ or substantially equal, plus or minus 20%, ideally plus or minus 5%. The greater the tolerance between the values of L, L₁, L₂ and L₃, the more the filtering level will be degraded.
The capacitor C_{FA}, C_{FA1}, C_{FA2}, C_{FA3}, respectively, is dimensioned so that the switching frequency F_{cfa} of the high-pass filter it forms with the inductor L_{FA}, L_{FA1}, L_{FA2}, L_{FA3}, respectively, is much lower than the switching frequency F_{dec} of the main converter and the compensator, or: F_{cfa}<<F_{dec}, typically 100×F_{cfa}<F_{dec}, so as to be sure to filter all the harmonics.
The switching frequency F_{dec} of the active compensator 62 is the same as that of the main converter 61.
The active compensator 62 and the main converter 61 share the same control circuit 3 and, as far as possible, the same driver types.

Thus, a method of controlling any of the system embodiments according to the invention previously described comprises a common control, by the control device 3, of the first set 1 and of the second set 2, by sending the switches of the switching cells a signal toggling the switches between their on state and their off state at the same switching frequency for all the switches so that:
for each switching cell, this switching cell oscillates between two states, a first state in which its first switch is on when its second switch is off, and a second state in which its first switch is off when its second switch is on,
for each pair of switching cells, the first switch 111, 121 of the switching cell of the first set of the pair is off when the first switch 211, 221 of the switching cell of the second set of the pair is on, and the first switch 111, 121 of the switching cell of the first set of the pair is on when the first switch 211, 221 of the switching cell of the second set of the pair is off.

The second set generates a current ripple of the same amplitude but in phase opposition to that generated by the first set.

To further illustrate the technical advantages of the invention over the state of the art, we will now provide a move detailed description of certain signal simulations within embodiments of systems according to the invention.

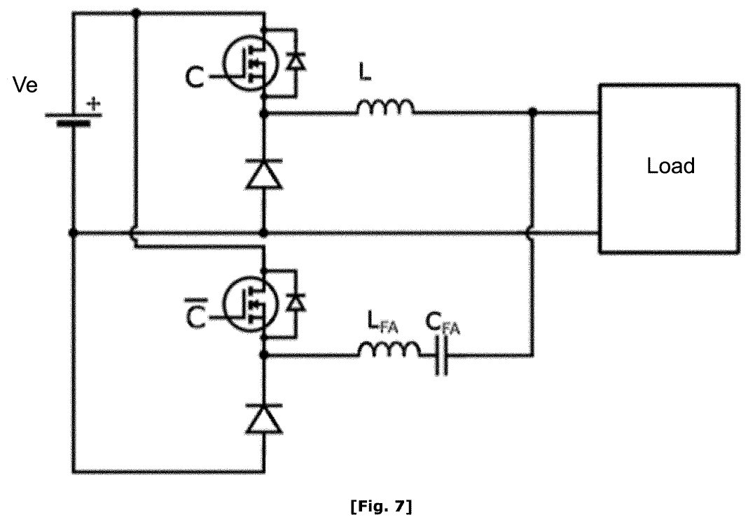

FIG. 7 shows a system 102 with a series chopper-type static converter 61 as shown in FIGS. 2a and 3a.

With reference to these three figures:
Ve is the converter input voltage 61
C is the opening (C=0) and closing (C=1) control of the transistor 111 of the main converter 61, and C̅ the complementary control of C driving the transistor 211 of the compensator 62
VT1 is the voltage across the transistor 111 of the main converter 61
VD1 is the voltage across the diode 112 of the main converter 61
IL1 is the current in the inductor L between the main converter 61 and the output 41, and Is its mean value
VD2 is the voltage across the diode 212 of the active compensator 62
ILfa is the current in the inductor L_{FA} between the active compensator 62 and the output 42
Icomp is the sum of the currents IL1 and ILfa (=load current).

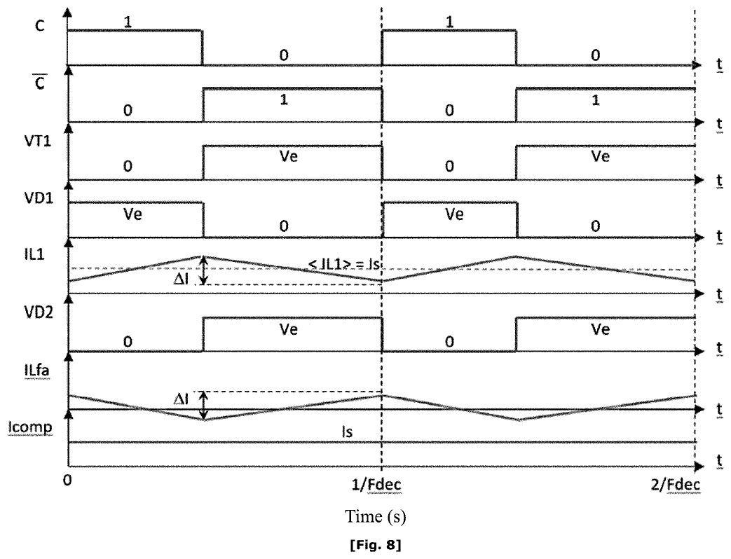

The corresponding waveforms are shown in FIG. 8 for two switching periods.

The result is excellent compensation. This would remain true whatever the duty cycle value of the switch control signals.

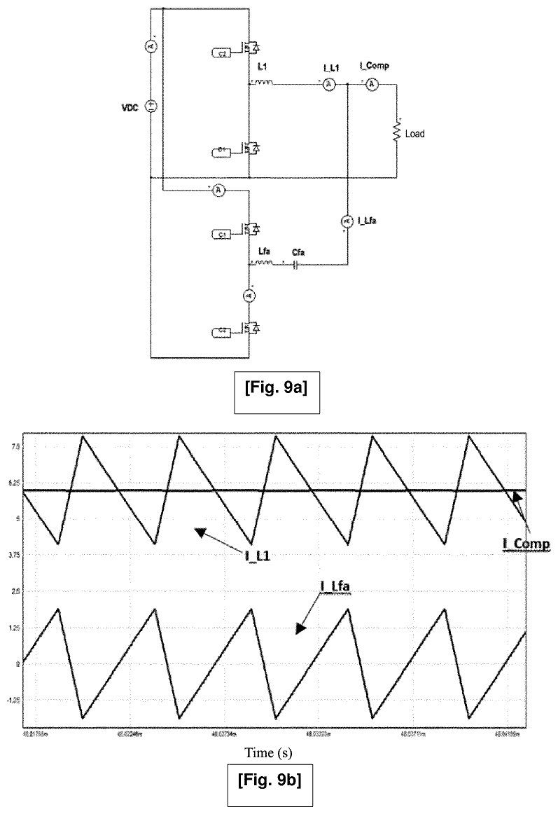

FIG. 9a is an electrical diagram, using PSIM electronic simulation software, of the system 103 shown in FIGS. 2a and 3b, with active compensator 62 associated with a current-reversible two-quadrant chopper.

FIG. 9b shows the validation of some of the signals (IL1, ILfa and Icomp identified in FIG. 9a) with the PSIM electronic simulation software for this system 103.

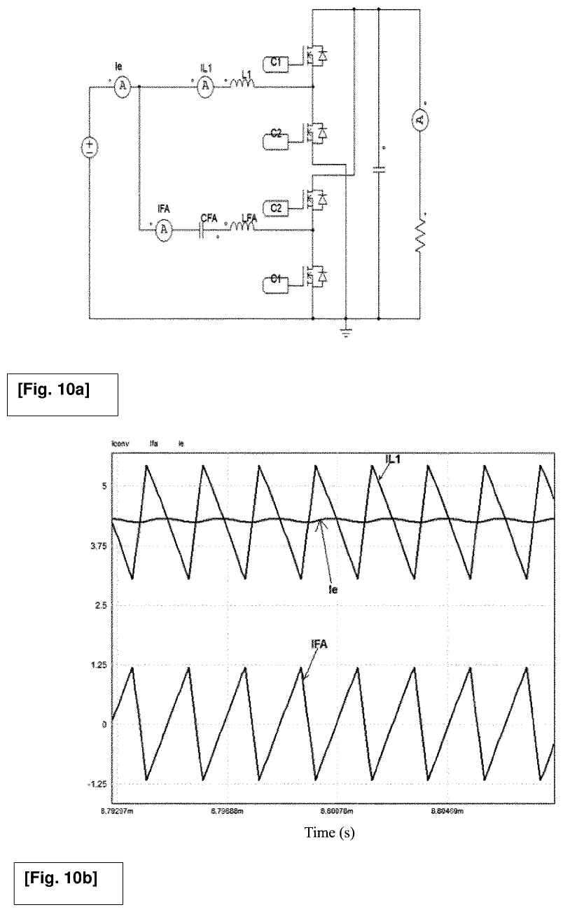

FIG. 10a is an electrical diagram, using PSIM electronic simulation software, of the system 303 shown in FIGS. 5a and 5b, with active compensator 62 associated with a parallel chopper.

FIG. 10b shows the validation of some of the signals (IL1, ILfa and le identified in FIG. 10a) with the PSIM electronic simulation software for this system 103.

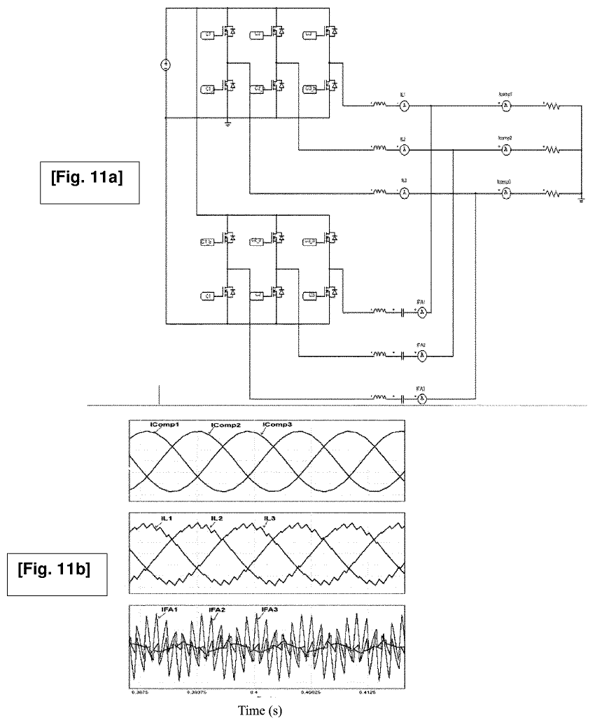

FIG. 11a is an electrical diagram, using PSIM electronic simulation software, of the system 504 shown in FIGS. 6a and 6b, with active compensator 62 associated with a three-phase inverter.

FIG. 11b shows the validation of some of the signals (IL1, IL2, IL3, IComp1, IComp2, IComp3, IFA1, IFA2, IFA3 identified in FIG. 11a) with the PSIM electronic simulation software for this system 103.

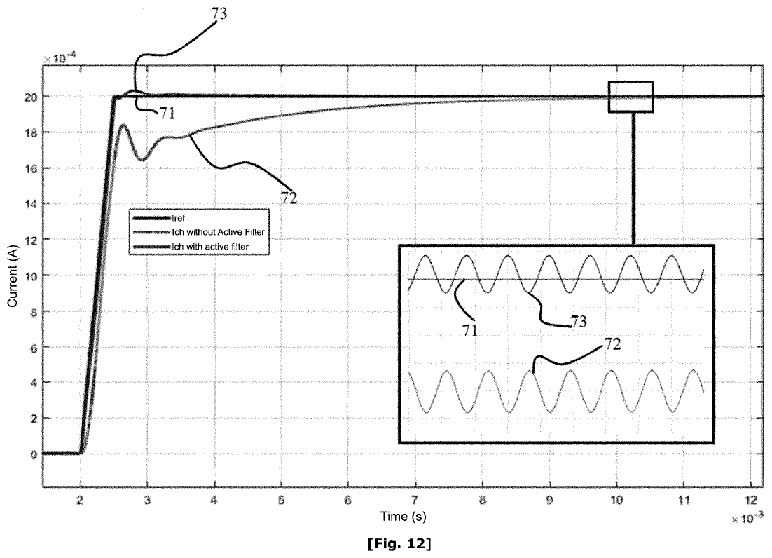

FIG. 12 shows a comparison, at a given load current filtering level, of the dynamics obtained for a reference 71 and with 73 and without 72 active compensator 62, for a system 104 of FIG. 3c with a 4-quadrant full-bridge chopper converter.

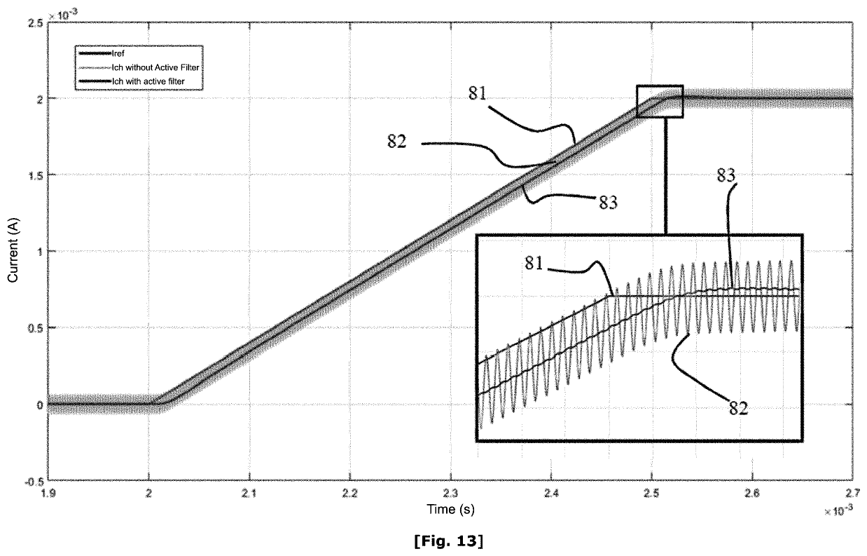

FIG. 13 shows a comparison, at a given bandwidth, of the filtering level obtained for a reference 81 and with 83 and without 82 active compensator, for a system 104 of FIG. 3c with a 4-quadrant full-bridge chopper converter.

Of course, the invention is not limited to the examples just described, and many adjustments can be made to these examples without going beyond the scope of the invention.

All the previously described embodiments can:
be adapted for current-to-voltage conversion, for example by simply swapping source and load, as shown in the diagrams in FIG. 2. In this case, the active compensator will filter the current, this time at the system input (and not at the output as in the case of voltage-to-current conversion), again generating a current ripple in phase opposition to the main converter. Thus, for example, in FIGS. 1, 3b, 3c, 4b, 4c, 4d, 5b, 6b and their corresponding descriptions, the source Vdc or reference 300 can be generalized to the case of a DC source or load, respectively, and the load or reference 400 can be generalized to the case of a load or source, respectively (DC or AC for FIG. 1, DC for FIG. 3b, DC or AC for FIG. 3c, DC for FIG. 4b, AC or DC for FIG. 4c or 4d, AC for FIG. 6). The invention can thus cover the case of a series chopper, step-up chopper, single-phase inverter, single-phase rectifier, etc.; and/or
be generalized to n pairs of switching cells or n switching cells per set 1 or 2 (n being a positive natural number). For example, the case of FIG. 3c is a case where n=2, but it is possible to envisage embodiments with n=3n n=4, etc.; and/or
consider that the switching cells of the same set 1 or 2 preferably have control signals phase-shifted by n between the two cells of the same set 1 or 2, or by 2n/n between the n cells of the same set 1 or 2, as this allows interleaving and an apparent load frequency n times greater than the frequency of the switches, and results in greater filter attenuation: for example, in the case n=2 in FIG. 3c, with a phase shift of n between cells 11 and 12 (and also between cells 21 and 22), the switches 111 and 112 in the cell 11 receive signals C and C̅, respectively, while the switches 121 and 122 in the cell 11 receive signals C̅ and C, respectively; and conversely, the switches 111 and 112 in the cell 11 receive signals C and C, respectively, while the switches 121 and 122 in the cell 11 receive signals C and C̅, but this can be generalized to any phase shift, even if these cases are less efficient; and/or
be generalized to q phases, with q a positive natural number; for example, the case in FIG. 3 is a case with q=I and the case in FIG. 6 is a case with q=3, but we can have q=4, 5, etc.

Additionally, the main converter switching cell(s) can be designed as a buck-boost chopper, and the compensator switching cell(s) can be designed as a buck-boost chopper.

Of course, the various features, forms, variants and embodiments of the invention may be combined with each other in various combinations as long as they are not incompatible or exclusive of each other. In particular, all the variants and embodiments described above can be combined with each other.

1-25. (canceled)

26. A voltage-to-current or current-to-voltage conversion system, comprising input terminals and output terminals, and between the input terminals and the output terminals:
a first set and a second set, each of the first set and the second set comprising at least one switching cell, and wherein:
the system further comprises a common control device for the first set and the second set,
each switching cell comprising:
a first switch, which can be in an on state or in an off state, and comprising a transistor, and
a second switch, which can be in an on state or an off state, and comprising a transistor and/or a diode,
so that, for each switching cell, this switching cell oscillates between two states, a first state in which its first switch is on when its second switch is off, and a second state in which its first switch is off when its second switch is on,
the number of switching cells in the system being even,
each of the first set and the second set comprises the same number of switching cell(s)
the at least one switching cell of the first set and the at least one switching cell of the second set being associated in pairs so that each switching cell of the first set is associated with a single switching cell of the second set, and each switching cell of the second set is associated with a single switching cell of the first set,
the control device being arranged and/or programmed to send to the switches of the switching cells a signal arranged to switch the switches between their on state and their off state at a same switching frequency F_{dec} for all the switches so that, for each pair of switching cells, the first switch of the switching cell of the first set of the pair is off when the first switch of the switching cell of the second set of the pair is on, and the first switch of the switching cell of the first set of the pair is on when the first switch of the switching cell of the second set of the pair is off.

27. The system according to claim 26, wherein the switching cells of the first set and of the second set together form a four-quadrant chopper structure.

28. The system according to claim 26, wherein the two sets are connected in parallel between the input terminals and the output terminals:
the first set comprising a main converter, each switching cell of the first set being a switching cell of the main converter, and
the second set comprising an switched-mode active compensator, each switching cell of the second set being a switching cell of the switched-mode active compensator.

29. The system according to claim 28, wherein the at least one switching cell of the main converter have a series chopper structure and the at least one switching cell of the compensator have a series chopper structure.

30. The system according to claim 28, wherein the at least one switching cell of the main converter have a two-quadrant chopper structure and the at least one switching cell of the compensator have a two-quadrant chopper structure.

31. The system according to claim 28, wherein the at least one switching cell of the main converter have a four-quadrant chopper structure and the at least one switching cell of the compensator have a four-quadrant chopper structure.

32. The system according to claim 26, wherein the second set is arranged to generate a current ripple of the same amplitude but in phase opposition to that generated by the first set.

33. The system according to claim 26, wherein the two first switches of the same pair of switching cells are connected to the same input terminal(s) and output terminal(s) without passing through a transistor or switch.

34. The system according to claim 26, wherein the two second switches of the same pair of switching cells are connected to the same input terminal(s) and output terminal(s) without passing through a transistor or switch.

35. The system according to claim 26, wherein no switching cell is connected to an input terminal via a transistor.

36. The system according to claim 26, wherein no switching cell is connected to an output terminal via a transistor.

37. The system according to claim 26, wherein each switching cell is connected to the two input terminals without any intermediate element.

38. The system according to claim 37, wherein each switching cell is connected to one of the output terminals without any intermediate element.

39. The system according to claim 37, wherein each switching cell is connected to one of the output terminals via an inductor.

40. The system according to claim 37, wherein each switching cell of the first set is connected to one of the output terminals via an inductor only.

41. The system according to claim 37, wherein switching cell of the second set is connected to one of the output terminals via an inductor and a capacitor.

42. The system according to claim 26, wherein each switching cell is connected to the two output terminals without any intermediate element.

43. The system according to claim 42, wherein each switching cell is connected to one of the input terminals without any intermediate element.

44. The system according to claim 42, wherein each switching cell is connected to one of the input terminals via an inductor.

45. The system according to claim 42, wherein each switching cell of the first set is connected to one of the input terminals via an inductor only.

46. The system according to claim 42, wherein each switching cell of the second set is connected to one of the input terminals via an inductor and a capacitor.

47. The system according to claim 46, wherein each inductor of the first set is coupled with an inductor of the second set.

48. The system according to claim 26, wherein the transistors of the switching cells comprise MOSFET and/or IGBT and/or GaN FET transistors.

49. A method of controlling the system according to claim 26, comprising a common control, by the control device, of the first set and of the second set, by sending the switches of the switching cells a signal toggling the switches between their on state and their off state at the same switching frequency for all the switches so that:
for each switching cell, this switching cell oscillates between two states, a first state in which its first switch is on when its second switch is off, and a second state in which its first switch is off when its second switch is on,
for each pair of switching cells, the first switch of the switching cell of the first set of the pair is off when the first switch of the switching cell of the second set of the pair is on, and the first switch of the switching cell of the first set of the pair is on when the first switch of the switching cell of the second set of the pair is off.

50. The method according to claim 49, wherein the second set generates a current ripple of the same amplitude but in phase opposition to that generated by the first set.
